(19) United States
(12) Patent Application Publication
(10) Pub. No.: US 2025/0131285 A1
(43) Pub. Date: Apr. 24, 2025

(54) SYSTEM AND METHOD FOR OPTIMIZED EVOLUTIONARY NEURAL ARCHITECTURE SEARCH

(71) Applicant: Cognizant Technology Solutions US Corp., Teaneck, NJ (US)

(72) Inventors: Xin QIU, Changzhou City (CN); Risto Miikkulainen, Stanford, CA (US)

(21) Appl. No.: 18/383,179

(22) Filed: Oct. 24, 2023

(51) Int. Cl. G06N 3/0985

(52) U.S. Cl. CPC G06N 3/0985

(57) ABSTRACT

A system and method for optimized evolutionary neural architecture search is provided. The present invention provides for generating at least two neural network architectures as two parents based on one or more received inputs. The neural network architectures are in the form of organized structures represented as computation graphs. A similarity is computed between the generated two neural network architectures by computing Graph Edit Distance (GED) between neural network architectures corresponding to computation graphs. Graph edit operations are executed for computing the GED. A Shortest Edit Path (SEP) crossover operation is carried out by analyzing computed edit paths between computation graphs. A shuffling operation is carried out randomly for shuffling edit paths in SEP between two parents by selecting half of shuffled edit paths randomly and applying selected edit paths to one of parents to generate an offspring graph for optimizing Neural Architecture Search (NAS) to solve real-world problems.

### FIELD OF THE INVENTION

The present invention relates generally to the field of evolutionary neural networks, and more particularly, to a system and a method for carrying out optimized evolutionary neural architecture search.

### BACKGROUND OF THE INVENTION

Evolutionary Neural Architecture Search (NAS) technique is generally carried out using evolutionary algorithms (EAs), which are based on natural evolution, for carrying out a population-based search. The NAS technique maintains a population of solutions, which are evolved using mutation and crossover operations. The mutation operation provides local search (i.e., refinement) and the crossover operation provides a directed global search, which leads to evolution of solutions.

Typically, it has been observed that the evolutionary NAS techniques are limited to carrying out only mutation operations without crossover operations due to ‘permutation problem’, also known as ‘competing conventions problem’. ‘Permutation problem’ arises due to isomorphisms in graph space, i.e., when functionally identical architectures are mapped to different encodings/representations, thereby making crossover operations disruptive. In other words, ‘permutation problem’ arises when the same architecture (i.e., a phenotype) can have multiple distinct genotypes. As a result, crossover on these genotypes has a disruptive effect on the information encoded in parents, leading to damaged child (i.e., offspring). Further, it has been observed that existing techniques either work only on fixed or constrained neural network topologies or are limited to one particular algorithm or search space, and none of the techniques operate on arbitrary graphs or NAS based architectures.

In light of the aforementioned drawbacks, there is a need for a system and a method which provides for an optimized evolutionary neural architecture search. There is a need for a system and a method which provides for application of improved crossover operations by the evolutionary NAS technique.

### SUMMARY OF THE INVENTION

In various embodiments of the present invention, a system for optimized evolutionary neural architecture search is provided. The system comprises a memory storing program instructions, a processor executing instructions stored in the memory and an evolutionary neural architecture search optimization engine. The evolutionary neural architecture search optimization engine is configured to generate at least two neural network architectures as two parents based on one or more received inputs. The neural network architectures are in the form of organized structures represented as computation graphs. The evolutionary neural architecture search optimization engine computes a similarity between the generated two neural network architectures by computing a Graph Edit Distance (GED) between the neural network architectures corresponding to the computation graphs. One or more graph edit operations are executed for computing the GED. Further, the evolutionary neural architecture search optimization engine carries out a Shortest Edit Path (SEP) crossover operation by analyzing computed edit paths between the graphs. A shuffling operation is carried out randomly for shuffling the edit paths in the SEP between the parents by selecting half of the shuffled edit paths randomly and applying selected edit paths to one of the parents to generate an offspring graph for optimizing Neural Architecture Search (NAS) to solve real-world problems.

In various embodiments of the present invention, a method for optimized evolutionary neural architecture search is provided. The method is implemented by a processor executing instructions stored in the memory. The method comprises generating at least two neural network architectures as two parents based on one or more received inputs. The neural network architectures are in the form of organized structures represented as computation graphs. The method comprises computing a similarity between the generated two neural network architectures by computing a Graph Edit Distance (GED) between the neural network architectures corresponding to the computation graphs. One or more graph edit operations are executed for computing the GED. Further, the method comprises carrying out a Shortest Edit Path (SEP) crossover operation by analyzing computed edit paths between the computation graphs. A shuffling operation is carried out randomly for shuffling the edit paths in the SEP between the two parents by selecting half of the shuffled edit paths randomly and applying selected edit paths to one of the parents to generate an offspring graph for optimizing Neural Architecture Search (NAS) to solve real-world problems.

In various embodiments of the present invention, a computer program product is provided. The computer program product comprises a non-transitory computer-readable medium having computer program code stored thereon, the computer-readable program code comprising instructions that, when executed by a processor, causes the processor to generate at least two neural network architectures as two parents based on one or more received inputs. The neural network architectures are in the form of organized structures represented as computation graphs. A similarity between the generated two neural network architectures is computed by computing a Graph Edit Distance (GED) between the neural network architectures corresponding to the computation graphs. One or more graph edit operations are executed for computing the GED. Further, a Shortest Edit Path (SEP) crossover operation is carried out by analyzing computed edit paths between the graphs. A shuffling operation is carried out randomly for shuffling the edit paths in the SEP between the parents by selecting half of the shuffled edit paths randomly and applying selected edit paths to one of the parents to generate an offspring graph for optimizing Neural Architecture Search (NAS) to solve real-world problems.

### BRIEF DESCRIPTION OF THE ACCOMPANYING DRAWINGS

The present invention is described by way of embodiments illustrated in the accompanying drawings wherein:

FIG. 1 is a detailed block diagram of a system for carrying out optimized evolutionary neural architecture search, in accordance with an embodiment of the present invention;

FIG. 2 illustrates a shuffling operation by randomly shuffling edit paths in the Shortest Edit Path (SEP) between parents, in accordance with an embodiment of the present invention;

FIG. 3 illustrates a comparison between a standard crossover operation and a SEP crossover operation, in accordance with an embodiment of the present invention;

FIG. 4 illustrates a graph providing comparison of SEP crossover and mutation technique, in accordance with an embodiment of the present invention;

FIGS. 5a and 5b illustrate a graphical representation providing comparison of the performance of random search, the original RE with mutation only, a modified RE augmented with standard crossover, RL and a modified RE augmented with the SEP crossover in a noise-free environment, in accordance with an embodiment of the present invention;

FIGS. 6a and 6b illustrate a graphical representation providing comparison of the performance of random search, RE with mutation-only, RE augmented with standard crossover, RL and RE augmented with the SEP crossover in a noisy environment, in accordance with an embodiment of the present invention; and

FIGS. 7 and 7A illustrate a flowchart depicting a method for carrying out optimized evolutionary neural architecture search, in accordance with an embodiment of the present invention; and

FIG. 8 illustrates an exemplary computer system in which various embodiments of the present invention may be implemented.

### DETAILED DESCRIPTION OF THE INVENTION

The present invention discloses a system and a method which provides an optimized evolutionary Neural Architecture Search (NAS) by overcoming ‘permutation problem’. The present invention provides for application of a new crossover operator by the evolutionary NAS technique based on a Shortest Edit Path (SEP) in an original graph space. Further, the present invention provides for a system and a method for carrying out NAS without any constraints on encoding or other algorithmic components and can be directly applied to any arbitrary neural architecture.

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the scope of the invention. The terminology and phraseology used herein is for the purpose of describing exemplary embodiments and should not be considered limiting. Thus, the present invention is to be accorded the widest scope encompassing numerous alternatives, modifications, and equivalents consistent with the principles and features disclosed herein. For purposes of clarity, details relating to technical material that is known in the technical fields related to the invention have been briefly described or omitted so as not to unnecessarily obscure the present invention.

The present invention would now be discussed in context of embodiments as illustrated in the accompanying drawings.

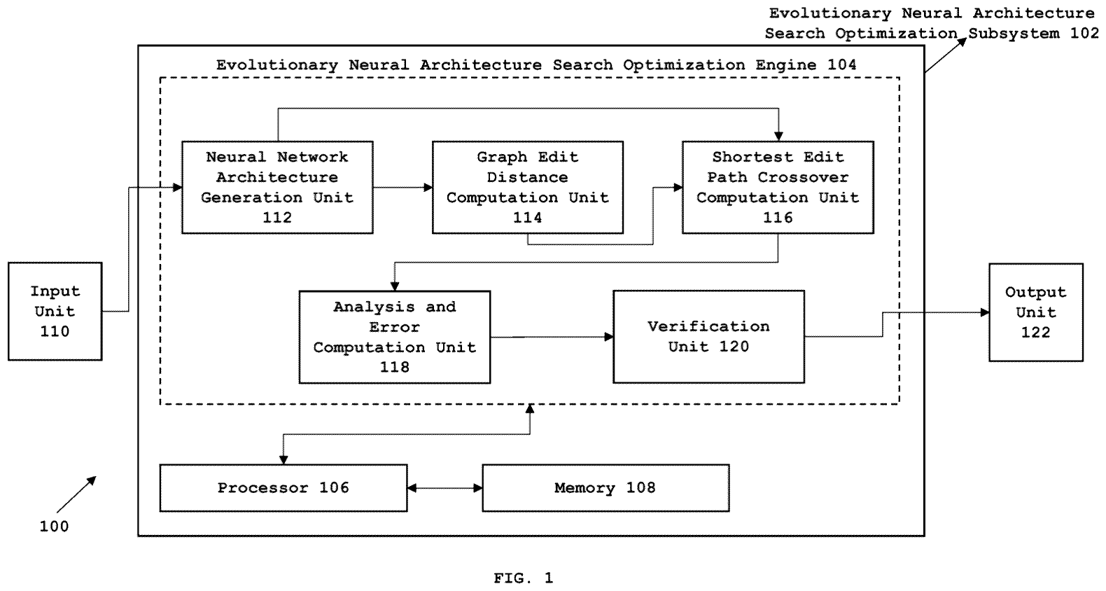

FIG. 1 is a detailed block diagram of a system 100 for carrying out optimized evolutionary neural architecture search (NAS), in accordance with various embodiments of the present invention. Referring to FIG. 1, in an embodiment of the present invention, the system 100 comprises an evolutionary neural architecture search optimization subsystem 102, an input unit 110 and an output unit 122. The input unit 110 and output unit 122 are connected to the subsystem 102 via a communication channel (not shown). The communication channel (not shown) may include, but is not limited to, a physical transmission medium, such as, a wire, or a logical connection over a multiplexed medium, such as, a radio channel in telecommunications and computer networking. Examples of radio channel in telecommunications and computer networking may include, but are not limited to, a Local Area Network (LAN), a Metropolitan Area Network (MAN) and a Wide Area Network (WAN).

In an embodiment of the present invention, the system 100 is configured with a built-in-intelligent mechanism for carrying out optimized evolutionary Neural Architecture Search (NAS). In an exemplary embodiment of the present invention, the subsystem 102 is configured to compute a new crossover operator based on a Shortest Edit Path (SEP) crossover technique between at least two neural network architectures (i.e., parents) in an original graph space for carrying out population-based search in NAS. The subsystem 100 is configured to overcome the ‘permutation problem’ for carrying out optimized evolutionary NAS based on the SEP crossover technique. In an embodiment of the present invention, a crossover operator associated with the SEP crossover technique generates an offspring architecture by recombining the two parents. The SEP crossover technique consists of an encoding (i.e., genotype) and a recombination strategy for adequately integrating the data associated with both the parents for generating the offspring, elaborated later in the specification.

In an embodiment of the present invention, the subsystem 102 comprises an evolutionary neural architecture search optimization engine 104 (engine 104), a processor 106 and a memory 108. In various embodiments of the present invention, the engine 104 is configured to carry out optimized evolutionary NAS. The various units of the engine 104 are operated via the processor 106 specifically programmed to execute instructions stored in the memory 108 for executing respective functionalities of the units of the engine 104 in accordance with various embodiments of the present invention.

In an embodiment of the present invention, the engine 104 comprises a neural network architecture generation unit 112, a Graph Edit Distance (GED) computation unit 114, a Short Edit Path (SEP) crossover computation unit 116, an analysis and error computation unit 118, and a verification unit 120.

In an embodiment of the present invention, the neural network architecture generation unit 112 is configured to receive inputs from the input unit 110 for generating at least two neural network architectures as parents. The neural network architectures are in the form of organized structures represented as computation graphs. The computation graph is represented by a directed graph (G). The inputs, therefore, relate to the directed graph, which includes a set of vertices (vᵢ) (i.e., nodes) and a set of directed edges (eᵢ) associated with the directed graph. The order of the directed graph (G) equals the number of its vertices, represented by |G|. For an attributed directed graph, a function γᵥ assigns an attribute (e.g., an integer) to each vertex, and a function γₑ assigns an attribute to each edge. For the NAS, each vertex with an attribute denotes an operation in a neural architecture, and the directed edges denote data flows.

In an embodiment of the present invention, the GED computation unit 114 is configured to compute similarity between the generated two neural network architectures based on computing a Graph Edit Distance (GED) between neural network architectures corresponding graphs (G₁ and G₂). In an embodiment of the present invention, the GED computation unit 114 is configured to execute one or more graph edit operations for computing the GED. The graph edit operation comprises application of an elementary graph edit technique which transforms G to G′. which represents an edited graph. In an exemplary embodiment of the present invention, a set of elementary graph edit technique associated with the NAS carries out at least a vertex deletion and insertion operation, an edge deletion and insertion operation, or a vertex attribute substitution operation. In an exemplary embodiment of the present invention, the graph edit operation is associated with computing an edit path, and is a sequence of graph edit operations. Further, GED between the two graphs (G₁ and G₂) associated with the neural network architectures relates to the set of all edit paths that transform the computation graph G₁ to G₂ or isomorphisms of G₂. In an embodiment of the present invention, all the edit operations have a value of 1. Therefore, the edit path that minimizes the total edit value comprises the SEP between G₁ and G₂. In an embodiment of the present invention, multiple SEP may be computed between G₁ and G₂ having same length.

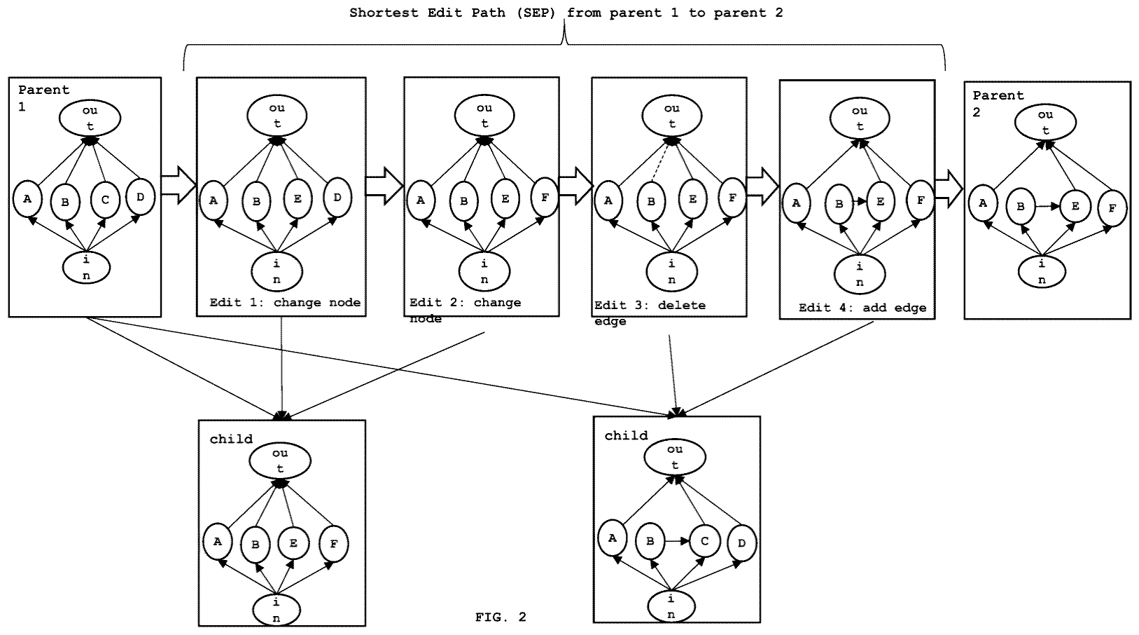

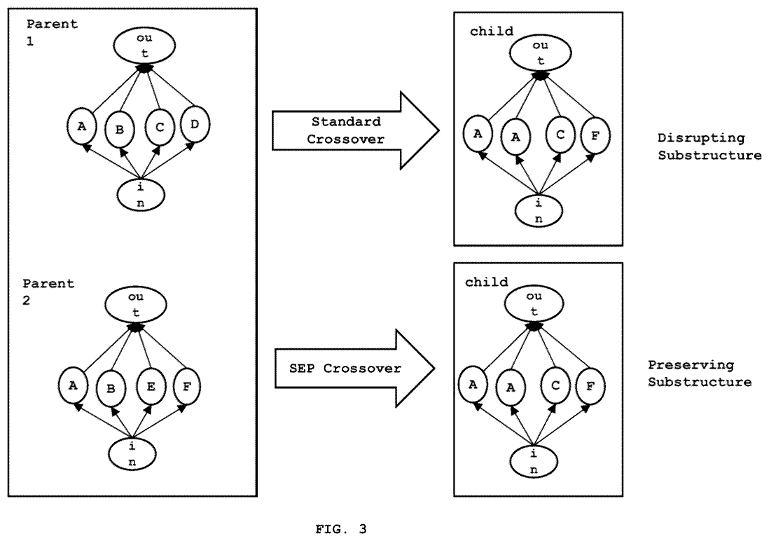

In an embodiment of the present invention, the SEP crossover computation unit 116 is configured to analyze the computed edit paths between the two graphs (G₁ and G₂) associated with neural network architectures for carrying out SEP crossover operation. The SEP crossover computation unit 116 is configured to carry out a shuffling operation for randomly shuffling the edit paths in the SEP between parents, as illustrated in FIG. 2. The SEP crossover computation unit 116 is further configured to carry out SEP crossover operation by selecting half of the shuffled edit paths randomly and thereafter applying the selected edit paths to one of the parents to generate a child graph (i.e., an offspring graph), as illustrated in FIG. 3. Referring to FIG. 3, the two parent architectures share vertices ‘A’ and ‘B’. Although the two vertices ‘A’ and ‘B’ appear in a different order, together they implement the same function, and this function should not be disrupted during crossover. As such, the standard crossover technique cannot identify the subgraph isomorphism, and it loses this substructure (disruptive structure). However, the shortest edit path computation recognizes the isomorphism, and as a result, the SEP crossover preserves this substructure (preserving structure). Thus, the SEP crossover technique analyzes the parts that are functionally inconsistent between the two parents. Therefore, the generated offspring graph is based on the SEP crossover technique. Advantageously, the offspring automatically preserves common substructures between parents, avoiding unnecessary disruptive behaviours and thus avoiding the ‘permutation problem’.

In an embodiment of the present invention, the analysis and error computation unit 118 is configured to generate an Attributed Adjacency matrix (AA-matrix) (A_{G}), as represented below, for analysis of efficiency of SEP crossover technique by communicating with the SEP crossover computation unit 116. Further, the analysis and error computation unit 118 is configured to generate an Attributed Adjacency matrix (AA-matrix) (A_{G}) for a mutation technique and subsequently the AA-matrix for both the SEP technique and mutation technique are compared for determining improvement of the SEP technique with respect to the mutation technique, as elaborated later in the specification. The AA-matrix represents the attributed directed graph (G). The AA-matrix is a ‘n×n’ matrix, where ‘n’ represents number of vertices (v) in ‘G’. The diagonal entries in the AA-matrix represents node attributes and non-diagonal entries in the AA-matrix represents edges. The entry in i^{th} row and j^{th} column is represented by A^{G}_{i,j}. As such, A^{G}_{i,j}=0, if there is no edge from vᵢ to vⱼ and, A^{G}_{i,j}=γₑ(e_{i,j}), if there exists an edge from vᵢ to vⱼ for i,j∈1, 2 . . . , n and i≠j. A^{G}_{i,j}=γᵥ(vᵢ), for i∈1, 2 . . . , n.

$${A}_{𝒢} = ( \begin{matrix}{A}_{1 , 1}^{𝒢} & {A}_{1 , 2}^{𝒢} & … & {A}_{1 , n}^{𝒢} \\ {A}_{2 , 1}^{𝒢} & {A}_{2 , 2}^{𝒢} & … & {A}_{2 , n}^{𝒢} \\ ⋮ & ⋮ & ⋱ & ⋮ \\ {A}_{n , 1}^{𝒢} & {A}_{n , 2}^{𝒢} & … & {A}_{n , n}^{𝒢}\end{matrix} )$$

In an embodiment of the present invention, the analysis and error computation unit 118 is configured to analyze SEP crossover technique by utilizing the generated AA-matrix. The analysis and error computation unit 118 is configured to firstly process the two computation graphs G₁ and G₂. G₁ and G₂ have a same order which is determined by adding null vertices resulting in G\hat{ }₁ and G\hat{ }₂. A crossover operation is carried out between G₁ and G₂ for generating a new offspring graph (G_{new}) by recombining A_{G\hat{ }1} and A_{G\hat{ }2} as A_{G\hat{ }new}=r (A_{G\hat{ }1}, Pπ A_{G\hat{ }2} Pπ^{T}), where AGA and A_{G\hat{ }2} is AA-matrix of G\hat{ }₁ and G\hat{ }₂, Pπ is a permutation matrix based on permutation π which is decided by the specific crossover operator utilized and function r(A,B) returns a matrix that inherits each entry from A or B with probability 0.5. For the SEP crossover technique, permutation is defined as π=π*_{G\hat{ }1,G\hat{ }2}, which minimizes the GED between G₁ and G₂. In an example, for the standard crossover technique, since the vertices may be in any order in the original AA-matrix representation and there is no particular vertex/edge matching mechanisms during crossover, a random permutation π_{rand} is used to represent the randomness. In an embodiment of the present invention, the analysis and error computation unit 118 therefore generates an AA-matrix (A_{G\hat{ }new}) of the generated new graph with null vertices associated with the SEP crossover technique. By removing all null vertices from G_{\hat{ }new} (new graph with null vertices), the crossover offspring graph is generated by the analysis and error computation unit 118.

In another embodiment of the present invention, the analysis and error computation unit 118 is configured to analyze mutation technique by utilizing the generated AA-matrix. The analysis and error computation unit 118 is configured to determine mutation operation by generating the new offspring graph (G_{new}) by mutating the graph G₁. In the AA-matrix representation, a mutation operation is then defined as A_{G\hat{ }new}=m(A_{G\hat{ }1}), where function m(A) alters each element of A with an equal probability pm, and pm is usually selected so that on average one element is altered during each mutation operation. The G\hat{ }₁ is the extended graph of G₁ with null vertices so that node additions can be performed in A_{G\hat{ }1}. An element A^{G\hat{ }1}_{i,j} can be altered in order to randomly resample an allowed value that is different from the original A^{G\hat{ }1}_{i,j}. The result A_{G} new, is the AA-matrix of the generated new graph with null vertices. By removing all null vertices from G_{\hat{ }new}, the mutated new offspring graph G_{new} is generated by the analysis and error computation unit 118.

In an embodiment of the present invention, the analysis and error computation unit 118 is configured to compute a main performance metric for SEP crossover and mutation operations for determining efficiency of SEP crossover and mutation operations based on a topological similarity to a global optimal graph. The expected improvement is referred to as E(max(dₑ(A_{G\hat{ }opt}, A_{G\hat{ }1 to G\hat{ }opt})−dₑ(A_{G\hat{ }opt}, A_{G\hat{ }1 to G\hat{ }opt}),0)), which compares the new offspring graph (G_{new}) with one parent graph G₁ in terms of the expected edge differences to Gₒₚₜ. Further, the max(., 0) part takes into account the selection pressure in standard EAs, that is, only the offspring that is better than its parent can survive and become the next parent. Further, the analysis and error computation unit 118 is configured to determine improvement of the SEP crossover by computing the below mentioned formula and the entries that are present in different AA-matrix and the permuted AA-matrix are assumed to be uniformly distributed on the positions other than those ns (number of common entries among multiple matrices) common entries:

let nₛₑ=max (n·(n−1)−d*_{e, G\hat{ }opt,G\hat{ }1}−d*_{e, G\hat{ }1,G\hat{ }2},0), where nₛₑ is number of common non-diagonal entries among multiple matrices and suppose A_{G\hat{ }new}=r(A_{G\hat{ }1}, Pπ*_{G\hat{ }1,G\hat{ }2} A_{G\hat{ }1}, Pπ^{T}*_{G\hat{ }1,G\hat{ }2}). Then E(max(dₑ(A_{G\hat{ }opt}, A_{G\hat{ }1 to G\hat{ }opt})−dₑ(A_{G\hat{ }opt}, A_{G\hat{ }new to G\hat{ }opt}), 0))≥E(max(d*_{e, G\hat{ }opt, G\hat{ }1}−d*_{e, G\hat{ }1,G\hat{ }2}−B(d*_{e, G\hat{ }1,G\hat{ }2}, 0.5),0))=LBEI_{SEPX}

n·(n−1)−nₛₑ

where B (d*_{e, G\hat{ }1,G\hat{ }2}, 0.5),0) denotes the number of successful trials after sampling from a binomial distribution with d*_{e, G\hat{ }1,G\hat{ }2} trials and success probability of 0.5, and LBEI_{SEPX} denotes the lower bound of expected improvement of the SEP crossover.

Further, the analysis and error computation unit 118 is configured to determine improvement of the mutation operation by computing the below mentioned formula:

Suppose A_{G\hat{ }new}=m(A_{G\hat{ }1}), then E(max(dₑ(A_{G\hat{ }opt}, A_{G\hat{ }1 to G\hat{ }opt})−dₑ(A_{G\hat{ }opt}, A_{G\hat{ }new to G\hat{ }opt}), 0))≥E(max(d*_{e, G\hat{ }opt,G\hat{ }1}−B(n·(n−1)−d*_{e, G\hat{ }opt,G\hat{ }1},pₘ)−B(d*_{e, G\hat{ }opt,G\hat{ }1}, 1−pₘ),0))=LBEI_{MUTA}, where pₘ is the mutation rate usually chosen to be pₘ=1/n. (n−1) and LBEI_{MUTA} denotes the lower bound of expected improvement of mutation.

In an embodiment of the present invention, the analysis and error computation unit 118 is configured to compute error during the GED determination between two neural network architectures extended graphs G\hat{ }₁, G\hat{ }₂. The error is computed based on the below mentioned formula:

$${d}_{e , G \hat{} 1 , G \hat{} 2}^{ϵ} = {d}_{e , G \hat{} 1 , G \hat{} 2}^{*} .$$

$$( 1 + ϵ ) ,$$

where ∈ (error ratio)>0 is the error ratio and d^{∈}_{e, G\hat{ }1, G\hat{ }2} is the expectation of GED computation result. The analysis and error computation unit 118 is configured to determine effect of GED errors on LBEI_{SPEX} and it is determined that the SEP crossover has an advantage in expected improvement compared to mutation and a standard crossover even with a very high error ratio (∈) of 30% in the GED calculations.

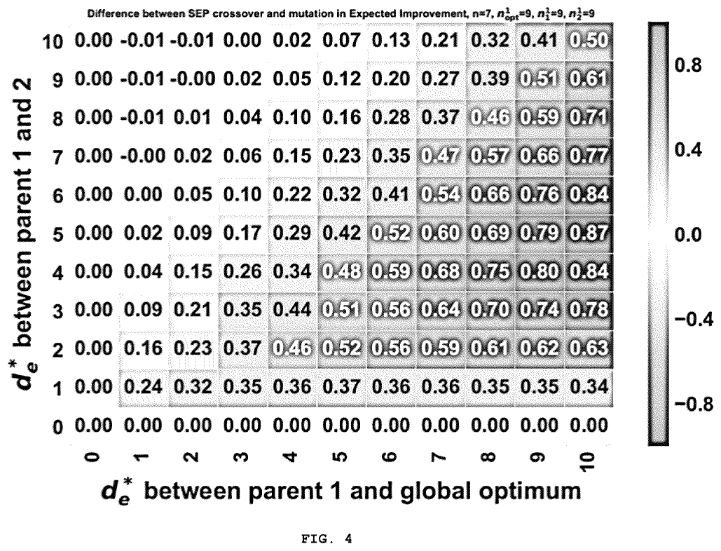

In an embodiment of the present invention, the verification unit 120 is configured to verify that parameter values, as elaborated above, used in analysis of the SEP crossover technique apply to real-world problems. The verification unit 120 is configured to firstly, verify that parameter values used in a Monte Carlo simulation lie within favorable regions in real NAS problems, prior to verifying that the parameter values used in analysis of the SEP crossover technique apply to real-world problems. The parameter values used for d*_{e,G\hat{ }opt, G\hat{ }1}, d*_{e,G\hat{ }1, G\hat{ }2}, n¹₁, n¹₂ are critical for the expected improvement and are verified in standard NAS benchmarks and with a standard NAS algorithm. The verification unit 120 is configured to apply the standard NAS benchmarks including a NAS-bench-101 and a NAS-bench-NLP to evaluate the parameter values used in the SEP crossover technique. In an embodiment of the present invention, the verification unit 120, firstly, evaluates the SEP crossover technique with the standard NAS technique by incorporating the SEP crossover technique into a Regularized Evolution (RE) method. As such, the RE method employs only a mutation operator and SEP crossover is integrated into the RE technique by alternating crossover with mutation. The verification unit 120, secondly, determines the parameter values by executing the RE on both the benchmarks (i.e., the NAS-bench-101 and the NAS-bench-NLP) and recording the relative frequency distributions of the above parameters. In an exemplary embodiment of the present invention, FIG. 4 illustrates a graph providing comparison of SEP crossover and mutation technique in the form of a heatmap. Further, as illustrated in FIG. 4, each entry in the heatmap shows the difference between SEP crossover technique and mutation technique in terms of expected improvement under one scenario. As such, in most scenarios, the SEP crossover technique has a better expected improvement as compared to the mutation technique (i.e., the number entries in the graph is positive). Then, in the experiments, SEP crossover technique is applied to some benchmark problems and the frequency for each scenario is recorded. The results show that when resolving real-world problems (i.e., the benchmarks), the frequently occurred scenarios illustrate that the SEP crossover technique has more improvement as compared to the mutation technique. Each value in the graph provides one situation and a difference as expected improvement of SEP crossover technique over the mutation technique. Therefore, SEP crossover technique is advantageous over the mutation technique.

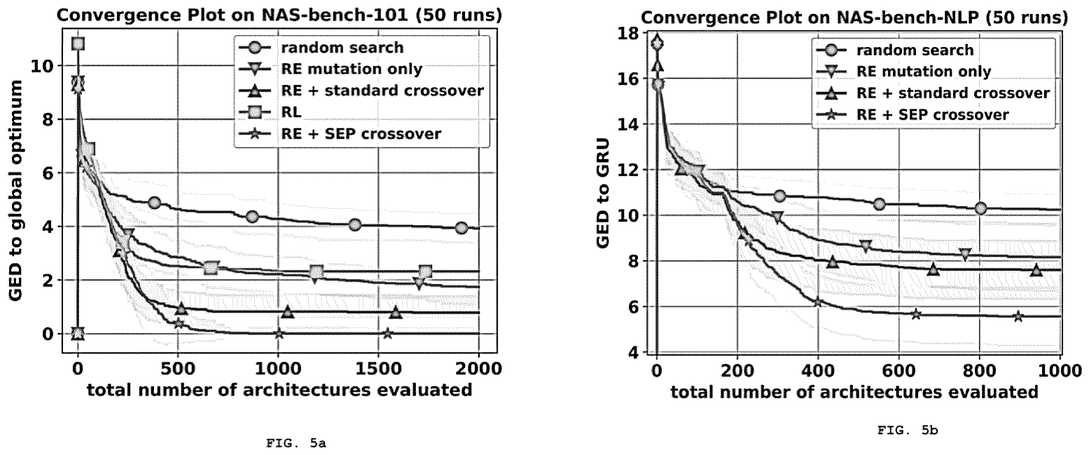

The newly developed SEP crossover technique, in accordance with various embodiments of the present invention, is employed in real-world NAS problems for determining search efficiency of the SEP crossover technique in a noise-free environment and a noisy environment. In one experiment, the search efficiency of the SEP crossover technique was determined in a noise-free environment. The evaluation step in NAS, i.e., the training and testing of an architecture, can be very noisy. In order to determine the search efficiency of the SEP crossover technique without the effects of such noise, a noise-free evaluation function was first employed as the GED between a candidate architecture and a target architecture. The global optimum was selected as the target in NAS-bench-101, while Gated Recurrent Unit (GRU) and Long-Short Term Memory (LSTM) models were used as targets in NAS-bench-NLP. As the NAS-bench-NLP is not queryable, the global optimum is unknown. However, GRU and LSTM are two known top-performing models in this search space and can therefore be used as a proxy for the global optimum. FIGS. 5a and 5b illustrate a graphical representation providing comparison of the performance of random search, the original RE with mutation only, a modified RE augmented with standard crossover, RL and a modified RE augmented with the SEP crossover. It was observed that the SEP crossover performs significantly better than the other methods, demonstrating its value in practical NAS in noise-free environments.

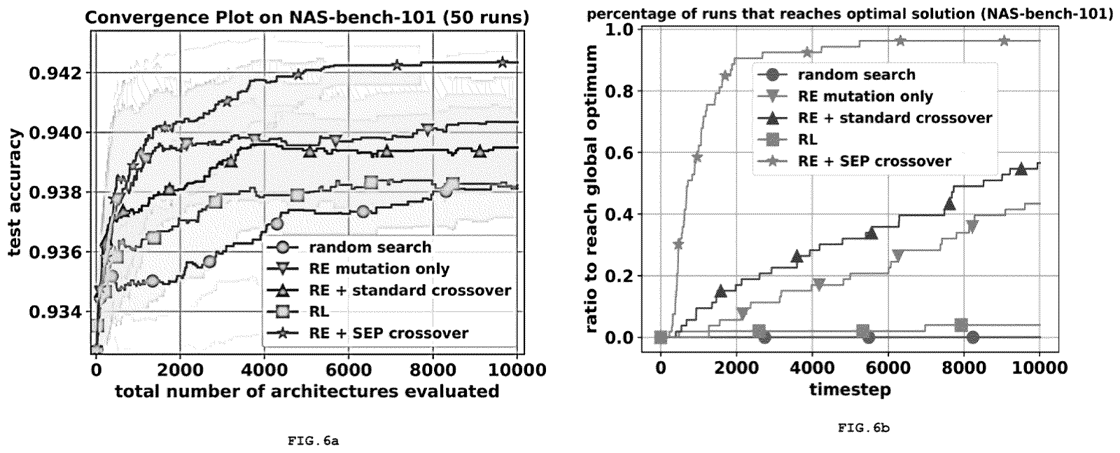

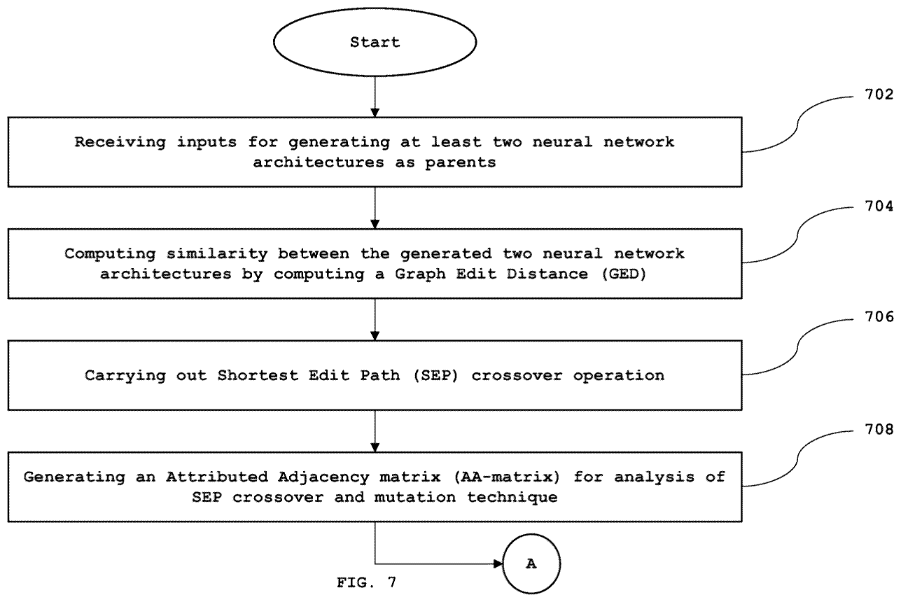

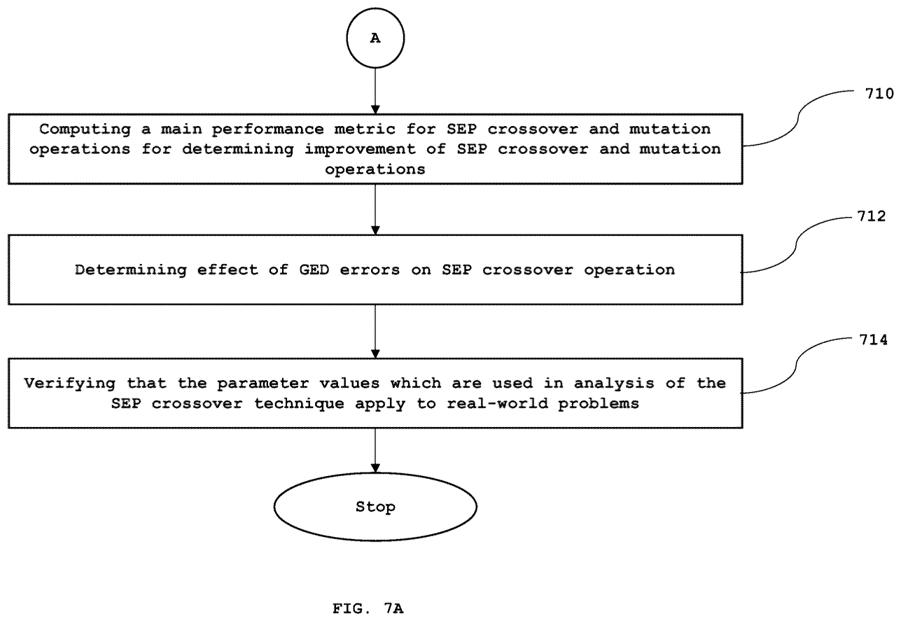

In another experiment, the search efficiency of the SEP crossover technique was determined in a noisy environment. The robustness of the SEP crossover was evaluated by applying the SEP crossover to NAS problems with noisy evaluations. Noise was caused from two sources: (1) the direct fitness/reward, e.g., the validation accuracy, used for search strategy was noisy; (2) mapping between the final objective e.g., the test accuracy, and direct fitness/reward was noisy. Further, the validation accuracy in NAS-bench-101, which consists of random sampling of three real-world training trials was used as the direct fitness/reward. The average test accuracy in NAS-bench-101 was used as the final objectives. FIGS. 6a and 6b illustrate a graphical representation providing comparison of the performance of random search, RE with mutation-only, RE augmented with standard crossover, RL and RE augmented with the SEP crossover. It was observed that the SEP crossover consistently outperforms other variants in this setup as well.

FIGS. 7 and 7A illustrate a flowchart depicting a method for carrying out optimized evolutionary neural architecture search, in accordance with various embodiments of the present invention.

At step 702, inputs are received for generating at least two neural network architectures as parents. In an embodiment of the present invention, the neural network architectures are in the form of organized structures represented as computation graphs. The computation graph is represented by a directed graph (G). The inputs, therefore, relate to the directed graph, which includes a set of vertices (vᵢ) (i.e., nodes) and a set of directed edges (eᵢ) associated with the directed graph. The order of the directed graph (G) equals the number of its vertices, represented by |G|. For an attributed directed graph, a function γᵥ assigns an attribute (e.g., an integer) to each vertex, and a function γₑ assigns an attribute to each edge. For the NAS, each vertex with an attribute denotes an operation in a neural architecture, and the directed edges denote data flows.

At step 704, similarity between the generated two neural network architectures is computed by computing a Graph Edit Distance (GED). In an embodiment of the present invention, the similarity is computed by computing a Graph Edit Distance (GED) between neural network architectures corresponding graphs (G₁ and G₂). In an embodiment of the present invention, one or more graph edit operations are executed for computing the GED. The graph edit operation comprises application of an elementary graph edit technique which transforms G to G′ which represents an edited graph. In an exemplary embodiment of the present invention, a set of elementary graph edits technique associated with the NAS carries out at least a vertex deletion and insertion operation, an edge deletion and insertion operation, or a vertex attribute substitution operation. In an exemplary embodiment of the present invention, the graph edit operation is associated with computing an edit path, and is a sequence of graph edit operations. GED between the two graphs (G₁ and G₂) associated with the neural network architectures relates to the set of all edit paths that transform computation graph G₁ to G₂ or isomorphisms of G₂. In an embodiment of the present invention, all the edit operations have a value of 1. Therefore, the edit path that minimizes the total edit value comprises the SEP between G₁ and G₂. In an embodiment of the present invention, multiple SEP may be computed between G₁ and G₂ having same length.

At step 706, Shortest Edit Path (SEP) crossover operation is carried out. In an embodiment of the present invention, the computed edit paths between the two graphs (G₁ and G₂) associated with neural network architectures are analyzed for carrying out SEP crossover operation. A shuffling operation is carried out for randomly shuffling the edit paths in the SEP between parents. SEP crossover operation is carried out by selecting half of the shuffled edit paths randomly and thereafter applying the selected edit paths to one of the parents to generate a child graph (i.e., an offspring graph). The two parent architectures share vertices ‘A’ and ‘B’. Although the two vertices ‘A’ and ‘B’ appear in a different order, together they implement the same function, and this function should not be disrupted during crossover. As such, the standard crossover technique cannot identify the subgraph isomorphism, and it loses this substructure (disruptive structure). However, the SEP computation recognizes the isomorphism, and as a result, the SEP crossover preserves this substructure (preserving structure). Thus, the SEP crossover technique analyses the parts that are functionally inconsistent between the two parents and is therefore employed to generate an offspring graph.

At step 708, an Attributed Adjacency matrix is generated for analysis of SEP crossover and mutation technique. In an embodiment of the present invention, the Attributed Adjacency matrix (AA-matrix) (A_{G}), as represented below, is generated for analysis of efficiency of SEP crossover technique. Further, an Attributed Adjacency matrix (AA-matrix) (A_{G}) is generated for a mutation technique and subsequently the AA-matrix for both the SEP technique and mutation technique are compared for determining improvement of SEP technique with respect to the mutation technique. The AA-matrix represents the attributed directed graph (G). The AA-matrix is a ‘n×n’ matrix, where ‘n’ represents number of vertices (v) in ‘G’. The diagonal entries in the AA-matrix represents node attributes and non-diagonal entries in the AA-matrix represents edges. The entry in i^{th} row and j^{th} column is represented by A^{G}_{i,j}. As such, A^{G}_{i,j}=0, if there is no edge from vᵢ to vⱼ and, A^{G}_{i,j}=γₑ(e_{i,j}), if there exists an edge from vᵢ to vⱼ for i,j∈1, 2 . . . , n and i≠j. A^{G}_{i,j}=γᵥ (vᵢ), for i∈1, 2 . . . , n.

$${A}_{𝒢} = ( \begin{matrix}{A}_{1 , 1}^{𝒢} & {A}_{1 , 2}^{𝒢} & … & {A}_{1 , n}^{𝒢} \\ {A}_{2 , 1}^{𝒢} & {A}_{2 , 2}^{𝒢} & … & {A}_{2 , n}^{𝒢} \\ ⋮ & ⋮ & ⋱ & ⋮ \\ {A}_{n , 1}^{𝒢} & {A}_{n , 2}^{𝒢} & … & {A}_{n , n}^{𝒢}\end{matrix} )$$

In an embodiment of the present invention, SEP crossover technique employs the generated AA-matrix for analysis. Firstly, the two computation graphs G₁ and G₂ are processed. G₁ and G₂ have a same order which is determined by adding null vertices resulting in G\hat{ }₁ and G\hat{ }₂. A crossover operation between G₁ and G₂ for generating a new offspring graph (G_{new}) is carried out by recombining A_{G\hat{ }1} and A_{G\hat{ }2} as A_{G\hat{ }new}=r (A_{G\hat{ }1}, Pπ A_{G\hat{ }2} Pπ^{T}), where A_{G\hat{ }1} and A_{G\hat{ }2} is AA-matrix of G\hat{ }₁ and G\hat{ }₂, Pπ is a permutation matrix based on permutation π which is decided by the specific crossover operator employed and function r(A,B) returns a matrix that inherits each entry from ‘A’ or ‘B’ with probability 0.5. For the SEP crossover, permutation π is defined as π=π*_{G\hat{ }1,G\hat{ }2}, which minimizes the GED between G₁ and G₂. In an example, for the standard crossover technique, since the vertices may be in any order in the original AA-matrix representation and there are no particular vertex/edge matching mechanisms during crossover, a random permutation π_{rand} is used to represent the randomness. In an embodiment of the present invention, an AA-matrix (A_{G\hat{ }new}) of the generated new graph is generated with null vertices associated with the SEP crossover technique. By removing all null vertices from G\hat{ }_{new}, the crossover offspring graph is generated.

In another embodiment of the present invention, mutation technique is analyzed by employing the generated AA-matrix. Mutation operation is determined based on generating a new offspring graph (G_{new}) by mutating the graph G₁. In the AA-matrix representation, a mutation operation is defined as A_{G\hat{ }new}=m (A_{G\hat{ }1}), where function m(A) alters each element of A with an equal probability pm, and pm is usually selected so that on average one element is altered during each mutation operation. The G\hat{ }₁ is the extended graph of G₁ with null vertices so that node additions can be performed in A_{G\hat{ }1}. An element A^{G\hat{ }1}_{i,j} can be altered in order to randomly resample an allowed value that is different from the original A^{G\hat{ }1}_{i,j}. The result A_{G\hat{ }new}, is the AA-matrix of the generated new graph with null vertices. By removing all null vertices from G\hat{ }_{new}, the mutated new offspring graph G_{new} is generated.

At step 710, a main performance metric is computed for SEP crossover and mutation operations for determining improvement of SEP crossover and mutation operations. In an embodiment of the present invention, the main performance metric is computed based on a topological similarity to the global optimal graph. The expected improvement is referred to as E(max(dₑ(A_{G\hat{ }opt}, A_{G\hat{ }1 to G\hat{ }opt})−dₑ(A_{G\hat{ }opt}, A_{G\hat{ }1 to G\hat{ }opt}),0)), which compares the new offspring graph (G_{new}) with one parent graph G₁ in terms of the expected edge differences to Gₒₚₜ. Further, the max(., 0) part takes into account the selection pressure in standard EAs, that is, only the offspring that is better than its parent can survive and become the next parent. Improvement of the SEP crossover is determined by computing the below mentioned formula and the entries that are present in different AA-matrix. The permuted AA-matrix are assumed to be uniformly distributed on the positions other than those ns (number of common entries among multiple matrices) common entries:

let nₛₑ=max(n·(n−1)−d*_{e, G\hat{ }opt,G\hat{ }1}−d*_{e, G\hat{ }1,G\hat{ }2},0), where nₛₑ is number of common non-diagonal entries among multiple matrices and suppose A_{G\hat{ }new}=r(A_{G\hat{ }1}, Pπ*_{G\hat{ }1,G\hat{ }2} A_{G\hat{ }1}, Pπ^{T}*_{G\hat{ }1,G\hat{ }2}). Then E(max(dₑ(A_{G\hat{ }opt}, A_{G\hat{ }1 to G\hat{ }opt})−dₑ(A_{G\hat{ }opt}, A_{G\hat{ }new to G\hat{ }opt}), 0))≥E(max(d*_{e, G\hat{ }opt, G\hat{ }1}−d*_{e, G\hat{ }1,G\hat{ }2}−B(d*_{e, G\hat{ }1,G\hat{ }2}, 0.5),0))=LBEI_{SE}

n·(n−1)−nₛₑ

where B(d*_{e, G\hat{ }1,G\hat{ }2}, 0.5),0) denotes the number of successful trials after sampling from a binomial distribution with d*_{e, G\hat{ }1,G\hat{ }2} trials and success probability of 0.5, and LBEI_{SEPX} denotes the lower bound of expected improvement of the SEP crossover.

Further, the improvement of the mutation operation is determined based on computing the below mentioned formula:

Suppose A_{G\hat{ }new}=m(A_{G\hat{ }1}), then E(max(dₑ(A_{G\hat{ }opt}, A_{G\hat{ }1 to G\hat{ }opt})−dₑ(A_{G\hat{ }opt}, A_{G\hat{ }new to G\hat{ }opt}), 0))≥E(max(d*_{e, G\hat{ }opt,G\hat{ }1}−B(n·(n−1)−d*_{e, G\hat{ }opt,G\hat{ }1},pₘ)−B(d*_{e, G\hat{ }opt,G\hat{ }1}, 1−pₘ),0))=LBEI_{MUTA}, where pₘ is the mutation rate usually chosen to be pₘ=1/n. (n−1) and LBEI_{MUTA} denotes the lower bound of expected improvement of mutation.

At step 712, effect of GED errors is determined on SEP crossover operation. In an embodiment of the present invention, error is computed during the GED determination between two neural network architecture extended graphs G\hat{ }₁, G\hat{ }₂. The error is computed based in the below mentioned formula:

$${d}_{e , G \hat{} 1 , G \hat{} 2}^{ϵ} = {d}_{e , G \hat{} 1 , G \hat{} 2}^{*} .$$

$$( 1 + ϵ ) ,$$

where ∈ (error ratio)>0 is the error ratio and d^{∈}_{e,G\hat{ }1,G\hat{ }2} is the expectation of GED computation result. Effect of GED errors are determined on LBEI_{SPEX} and it is ascertained that the SEP crossover has an advantage in expected improvement compared to mutation and a standard crossover even with a very high error ratio (∈) of 30% in the GED calculations.

At step, 714, parameter values which are used in analysis of the SEP crossover technique are verified that they apply to real-world problems. In an embodiment of the present invention, firstly, it is verified that parameter values used in a Monte Carlo simulation lie within favorable regions in real NAS problems, prior to verifying that the parameter values used in analysis of the SEP crossover technique apply to real-world problems. The parameter values used for d*_{e,G\hat{ }opt, G\hat{ }1}, d*_{e,G\hat{ }1, G\hat{ }2}, n¹₁, n¹₂ are critical for the expected improvement and are verified in standard NAS benchmarks with a standard NAS algorithm. The standard NAS benchmarks apply a NAS-bench-101 and a NAS-bench-NLP to evaluate the parameter values used in the SEP crossover technique. In an embodiment of the present invention, firstly, the SEP crossover technique is evaluated with the standard NAS algorithm by incorporating the SEP crossover technique into a Regularized Evolution (RE) method. The RE method employs only a mutation operator and SEP crossover is integrated into the RE technique by alternating crossover with mutation. Secondly, the parameter values are determined by executing the RE on both the benchmarks (i.e., the NAS-bench-101 and the NAS-bench-NLP) and recording the relative frequency distributions of the above parameters.

Advantageously, in accordance with various embodiments of the present invention, the present invention provides for a system and method for carrying out optimized evolutionary neural architecture search by employing the new SEP crossover technique. The present invention provides for effectively resolving the ‘permutation problem’ associated with existing NAS techniques, thereby providing an improved NAS system and method. The present invention provides for carrying out NAS without any constraints on encoding or other algorithmic components and can be directly applied to any arbitrary neural architectures. Further, the present invention provides for robust and effective application of SEP crossover in realistic noisy environments as well. Furthermore, the present invention provides for reducing the computational costs during the NAS operations.

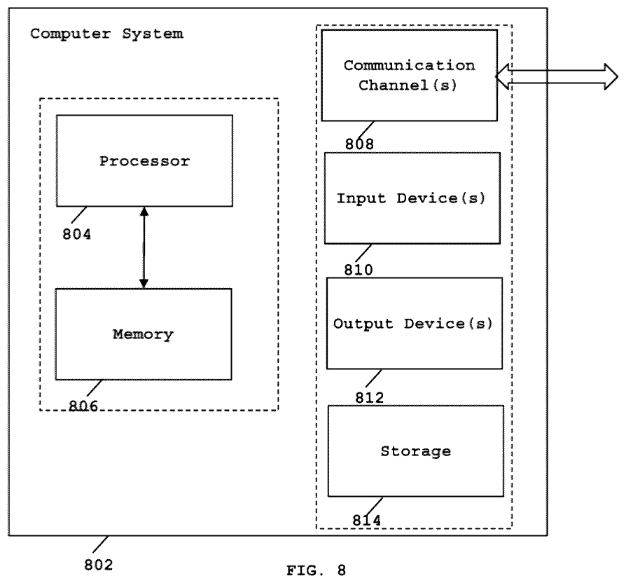

FIG. 8 illustrates an exemplary computer system in which various embodiments of the present invention may be implemented. The computer system 802 comprises a processor 804 and a memory 806. The processor 804 executes program instructions and is a real processor. The computer system 802 is not intended to suggest any limitation as to scope of use or functionality of described embodiments. For example, the computer system 802 may include, but not limited to, a programmed microprocessor, a micro-controller, a peripheral integrated circuit element, and other devices or arrangements of devices that are capable of implementing the steps that constitute the method of the present invention. In an embodiment of the present invention, the memory 806 may store software for implementing various embodiments of the present invention. The computer system 802 may have additional components. For example, the computer system 802 includes one or more communication channels 808, one or more input devices 810, one or more output devices 812, and storage 814. An interconnection mechanism (not shown) such as a bus, controller, or network, interconnects the components of the computer system 802. In various embodiments of the present invention, operating system software (not shown) provides an operating environment for various software executing in the computer system 802 and manages different functionalities of the components of the computer system 802.

The communication channel(s) 808 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, Bluetooth or other transmission media.

The input device(s) 810 may include, but not limited to, a keyboard, mouse, pen, joystick, trackball, a voice device, a scanning device, touch screen or any another device that is capable of providing input to the computer system 802. In an embodiment of the present invention, the input device(s) 810 may be a sound card or similar device that accepts audio input in analog or digital form. The output device(s) 812 may include, but not limited to, a user interface on CRT or LCD, printer, speaker, CD/DVD writer, or any other device that provides output from the computer system 802.

The storage 814 may include, but not limited to, magnetic disks, magnetic tapes, CD-ROMs, CD-RWs, DVDs, flash drives or any other medium which can be used to store information and can be accessed by the computer system 802. In various embodiments of the present invention, the storage 814 contains program instructions for implementing the described embodiments.

The present invention may suitably be embodied as a computer program product for use with the computer system 802. The method described herein is typically implemented as a computer program product, comprising a set of program instructions which is executed by the computer system 802 or any other similar device. The set of program instructions may be a series of computer readable codes stored on a tangible medium, such as a computer readable storage medium (storage 814), for example, diskette, CD-ROM, ROM, flash drives or hard disk, or transmittable to the computer system 802, via a modem or other interface device, over either a tangible medium, including but not limited to optical or analogue communications channel(s) 808. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as a system, a method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the scope of the invention.

We claim:

1. A system for optimized evolutionary neural architecture search, the system comprising:
a memory storing program instructions;
a processor executing instructions stored in the memory; and
an evolutionary neural architecture search optimization engine and configured to:
generate at least two neural network architectures as two parents based on one or more received inputs, wherein the neural network architectures are in the form of organized structures represented as computation graphs;
compute a similarity between the generated two neural network architectures by computing a Graph Edit Distance (GED) between the neural network architectures corresponding to the computation graphs, wherein one or more graph edit operations are executed for computing the GED; and
carry out a Shortest Edit Path (SEP) crossover operation by analyzing computed edit paths between the graphs, wherein a shuffling operation is carried out randomly for shuffling the edit paths in the SEP between the parents by selecting half of the shuffled edit paths randomly and applying selected edit paths to one of the parents to generate an offspring graph for optimizing Neural Architecture Search (NAS) to solve real-world problems.

2. The system as claimed in claim 1, wherein the computation graphs are represented by a directed graph (G), and wherein the received inputs relate to the directed graph which includes a set of vertices (vᵢ) (nodes) and a set of directed edges (eᵢ) associated with the directed graph, and wherein the order of the directed graph (G) equals the number of its vertices which is represented by |G|.

3. The system as claimed in claim 1, wherein the evolutionary neural architecture search optimization engine comprises a Graph Edit Distance (GED) computation unit executed by the processor and configured to execute the one or more graph edit operations for computing the GED, the graph edit operation comprises application of an elementary graph edit technique which transforms a directed graph (G) to G′ which represents an edited graph, and wherein a set of elementary graph edit technique carries out a vertex deletion and insertion operation, an edge deletion and insertion operation, or a vertex attribute substitution operation.

4. The system as claimed in claim 1, wherein the GED between the one or more computation graphs relates to the computed edit paths that transform the computation graph G₁ to G₂ or isomorphisms of G₂, the graph edit operation has a value of 1, and wherein the edit path that minimizes the total edit value comprises a Shortest Edit Path (SEP) between G₁ and G₂, and wherein multiple SEPs are computed between G₁ and G₂ having a same length.

5. The system as claimed in claim 1, wherein the SEP crossover operation employs a SEP technique that analyzes parts that are functionally inconsistent between the two parents.

6. The system as claimed in claim 4, wherein the evolutionary neural architecture search optimization engine comprises an analysis and error computation unit executed by the processor and configured to determine efficiency of the SEP crossover technique by generating an Attributed Adjacency matrix (AA-matrix) which represents an attributed directed graph (G), and wherein a main performance metric is computed for determining efficiency of the SEP crossover technique.

7. The system as claimed in claim 6, wherein the analysis and error computation unit is configured to process the computation graphs G₁ and G₂, and wherein G₁ and G₂ have a same order which is determined by adding null vertices resulting in the neural network architectures G\hat{ }₁ and G\hat{ }₂, and wherein a crossover operation is carried out between G₁ and G₂ for generating the offspring graph by recombining AA-matrix of G\hat{ }₁ and G\hat{ }₂ represented as A_{G\hat{ }}₁ and A_{G\hat{ }}₂, and wherein the analysis and error computation unit generates a new AA-matrix (A_{G\hat{ }new}) of a new offspring graph (G_{new}) with null vertices associated with the SEP crossover operation, and wherein the crossover offspring graph is generated by removing all null vertices from the new offspring graph with null vertices (G _{new}).

8. The system as claimed in claim 7, wherein the analysis and error computation unit computes the main performance metric for determining efficiency of the SEP crossover technique based on a topological similarity to a global optimal graph, the efficiency of the SEP crossover technique is determined by comparing the new offspring graph (G_{new}) with one of the computation graphs G₁ in terms of the expected edge differences to Gₒₚₜ.

9. The system as claimed in claim 7, wherein the analysis and error computation unit which is configured to compute an error during the GED determination between the two neural network architectures G\hat{ }₁, G\hat{ }₂.

10. The system as claimed in claim 8, wherein the evolutionary neural architecture search optimization engine comprises a verification unit executed by the processor and configured to verify that parameter values used in a Monte Carlo simulation lie within favorable regions in real NAS problems, prior to verifying that one or more parameter values used in analysis of the SEP crossover technique apply to the real-world problems, and wherein the verification unit is configured to apply one or more standard NAS benchmarks including a NAS-bench-101 and a NAS-bench-NLP to evaluate the parameter values used in the SEP crossover technique.

11. The system as claimed in claim 10, wherein the verification unit evaluates the SEP crossover operation with the standard NAS technique by incorporating a SEP crossover technique employed in the SEP crossover operation into a Regularized Evolution (RE) method, and wherein the verification unit determines the parameter values by executing the RE method on both the benchmarks including the NAS-bench-101 and the NAS-bench-NLP and recording the relative frequency distributions of the parameters.

12. A method for optimized evolutionary neural architecture search, the method is implemented by a processor executing instructions stored in the memory, the method comprises:
generating at least two neural network architectures as two parents based on one or more received inputs, wherein the neural network architectures are in the form of organized structures represented as computation graphs;
computing a similarity between the generated two neural network architectures by computing a Graph Edit Distance (GED) between the neural network architectures corresponding to the computation graphs, wherein one or more graph edit operations are executed for computing the GED; and
carrying out a Shortest Edit Path (SEP) crossover operation by analyzing computed edit paths between the computation graphs, wherein a shuffling operation is carried out randomly for shuffling the edit paths in the SEP between the two parents by selecting half of the shuffled edit paths randomly and applying selected edit paths to one of the parents to generate an offspring graph for optimizing Neural Architecture Search (NAS) to solve real-world problems.

13. The method as claimed in claim 12, wherein the computation graphs are represented by a directed graph (G), and wherein the received inputs relate to the directed graph which includes a set of vertices (vᵢ) (nodes) and a set of directed edges (eᵢ) associated with the directed graph, and wherein the order of the directed graph (G) equals the number of its vertices which is represented by |G|.

14. The method as claimed in claim 12, wherein the graph edit operation comprises application of an elementary graph edit technique which transforms a directed graph (G) to G′ which represents an edited graph, and wherein a set of elementary graph edit technique carries out a vertex deletion and insertion operation, an edge deletion and insertion operation, or a vertex attribute substitution operation.

15. The method as claimed in claim 12, wherein the GED between the computation graphs relates to the computed edit paths that transform the computation graph G₁ to G₂ or isomorphisms of G₂, the graph edit operation has a value of 1, and wherein the edit path that minimizes the total edit value comprises a Shortest Edit Path (SEP) between G₁ and G₂, and wherein multiple SEPs are computed between G₁ and G₂ having a same length.

16. The method as claimed in claim 12, wherein the SEP crossover operation employs a SEP technique that analyzes parts that are functionally inconsistent between the two parents.

17. The method as claimed in claim 15, wherein efficiency of SEP crossover technique is determined by generating an Attributed Adjacency matrix (AA-matrix) which represents an attributed directed graph (G), and wherein a main performance metric is computed for determining efficiency of the SEP crossover technique.

18. The method as claimed in claim 17, wherein the two computation graphs G₁ and G₂ have a same order which is determined by adding null vertices resulting in G\hat{ }₁ and G\hat{ }₂, and wherein a crossover operation is carried out between G₁ and G₂ for generating the offspring graph by recombining A_{G\hat{ }}₁ and A_{G\hat{ }}₂, and wherein a new AA-matrix (A_{G\hat{ }new}) is generated of a new offspring graph (G_{new}) with null vertices associated with the SEP crossover technique, and wherein the crossover offspring graph is generated by removing all null vertices from the new offspring graph with null vertices (G_{G\hat{ }new}).

19. The method as claimed in claim 17, wherein the main performance metric is computed for determining efficiency of the SEP crossover technique based on a topological similarity to a global optimal graph, the efficiency of the SEP crossover technique is determined by comparing the new offspring graph (G_{new}) with one of the computation graphs G₁ in terms of the expected edge differences to Gₒₚₜ.

20. The method as claimed in claim 19, wherein parameter values used in a Monte Carlo simulation are verified to determine whether the parameter values lie within favorable regions in real NAS problems, prior to verifying that one or more parameter values used in analysis of the SEP crossover technique apply to the real-world problems, and wherein one or more standard NAS benchmarks are applied including a NAS-bench-101 and a NAS-bench-NLP to evaluate the parameter values used in the SEP crossover technique.

21. The method as claimed in claim 20, wherein the SEP crossover technique is evaluated with the standard NAS technique by incorporating the SEP crossover technique into a Regularized Evolution (RE) method, and wherein the verification unit determines the parameter values by executing the RE method on both the benchmarks including the NAS-bench-101 and the NAS-bench-NLP and recording the relative frequency distributions of the parameters.

22. A computer program product comprising:
a non-transitory computer-readable medium having computer program code stored thereon, the computer-readable program code comprising instructions that, when executed by a processor, causes the processor to:
generate at least two neural network architectures as two parents based on one or more received inputs, wherein the neural network architectures are in the form of organized structures represented as computation graphs;
compute a similarity between the generated two neural network architectures by computing a Graph Edit Distance (GED) between the neural network architectures corresponding to the computation graphs, wherein one or more graph edit operations is executed for computing the GED; and
carry out a Shortest Edit Path (SEP) crossover operation by analyzing computed edit paths between the graphs, wherein a shuffling operation is carried out randomly for shuffling the edit paths in the SEP between the parents by selecting half of the shuffled edit paths randomly and applying selected edit paths to one of the parents to generate an offspring graph for optimizing Neural Architecture Search (NAS) to solve real-world problems.
